(19) United States
(12) Patent Application Publication
(10) Pub. No.: US 2025/0258477 A1
(43) Pub. Date: Aug. 14, 2025

(54) DIAGNOSIS DATA COLLECTION DEVICE, DIAGNOSIS DATA COLLECTION METHOD, RECORDING MEDIUM, AND CONTROL DEVICE

(71) Applicant: FANUC CORPORATION, Minamitsuru-gun, Yamanashi (JP)

(72) Inventor: Mamoru KUBO, Yamanashi (JP)

(21) Appl. No.: 18/856,335

(22) PCT Filed: Apr. 25, 2022
(86) PCT No.: PCT/JP2022/018715

§ 371 Date: Oct. 11, 2024

(51) Int. Cl. G05B 19/4065; G05B 19/408

(52) U.S. Cl. CPC G05B 19/4065; G05B 19/408

(57) ABSTRACT

The present invention suppresses expansion of data by early determining the type of machining having no relation to a diagnosis and excluding waveform data of the machining without preserving said waveform data. This diagnosis data collection device is for collecting data for a diagnosis of a machine tool performing machining composed of a plurality of machining types. Said diagnosis data collection device comprises: a collection unit that collects, in a time sequence, data of the machine tool at the time of machining operation; a machining type determination unit that determines, on the basis of the collected data, a machining type of the machine tool for each machining period; and a data exclusion unit that, when the determined machining type is a machining type which is to be excluded and for which data collection is set as unnecessary in advance, excludes the data of the machining type in the machining period.

### TECHNICAL FIELD

The present invention pertains to a diagnosis data collection device, a diagnosis data collection method, a recording medium, and a control device.

### BACKGROUND ART

In order to diagnose a machine tool, servo waveform data such as a motor torque when machining is collected and analyzed in time series.

On this point, a tool breakage detection technique that determines a tool breakage in accordance with a sudden drop in motor torque when cutting is known. For example, refer to Patent Document 1.

In addition, a tool wear monitoring technique that determines a degree of tool wear from an increase in motor torque when cutting is known. For example, refer to Patent Documents 2 and 3.

In addition, a failure prediction technique that calculates an abnormality level in accordance with a comparison with a normal model for motor torque, in accordance with artificial intelligence (AI), is known. For example, refer to Patent Document 4.

Note that, for the purpose of later analysis, collected waveform data is often saved in a HDD (hard disk drive) or the like in a semi-permanent manner.

### CITATION LIST

### Patent Document

Patent Document 1: Japanese Patent No. 3883485
Patent Document 2: Japanese Patent No. 3681733
Patent Document 3: Japanese Unexamined Patent Application, Publication No. H11-58113
Patent Document 4: Japanese Patent No. 6140331

### DISCLOSURE OF THE INVENTION

### Problems to be Solved by the Invention

Incidentally, waveform data has a short collection interval (for example, 1 ms or the like), and thus the data size thereof becomes large (for example, 10 GB or the like per day for one machine tool).

Accordingly, an increase in waveform data arises due to saving waveform data for all machining.

In addition, required memory capacity will increase due to the increase in waveform data, and the capacity of a storage device for saving waveform data will be insufficient. In addition, there is also the possibility of exceeding a memory limit specification of, inter alia, a machine diagnostic device that uses the waveform data.

Furthermore, a cost increase occurs in conjunction with the increase of the required memory capacity.

Note that, depending on an intended use or machining details, there are many cases where waveform data for specific machining is unnecessary. For example, in the case of tool breakage detection, it may be that a milling tool that is not likely to bend in milling is set as to be excluded. In addition, in a case of tool wear monitoring or tool breakage detection, it may be that waveform data for only a drill is saved, and other data is excluded.

Accordingly, it is desirable to quickly determine a type of machining having no relation to a diagnosis and exclude waveform data of this machining without saving said waveform data to thereby suppress an increase in data.

### Means for Solving the Problems

(1) One aspect of a diagnosis data collection device according to the present disclosure is a diagnosis data collection device for collecting data for diagnosing a machine tool that performs machining constituted by a plurality of machining types, the diagnosis data collection device including: a collection unit configured to collect, in time series, data when the machine tool is machining; a machining type determination unit configured to determine a machining type for each machining time period for the machine tool, based on the collected data; and a data exclusion unit configured to, in a case where the determined machining type is an exclusion-target machining type for which collection of data is preset to unnecessary, exclude data on the machining time period for the determined machining type.

(2) One aspect of a diagnosis data collection method according to the present disclosure is a diagnosis data collection method for collecting data for diagnosing a machine tool that performs machining constituted by a plurality of machining types, the method including: a collection step of collecting, in time series, data when the machine tool is machining; a machining type determination step of determining a machining type for each machining time period for the machine tool, based on the collected data; and a data exclusion step of, in a case where the determined machining type is an exclusion-target machining type for which collection of data is preset to unnecessary, excluding data on the machining time period for the determined machining type.

(3) One aspect of a recording medium according to the present disclosure is a computer-readable recording medium on which is recorded a program for causing a computer to, in order to collect data for diagnosing a machine tool that performs machining constituted by a plurality of machining types, function as: a collection unit configured to collect, in time series, data when the machine tool is machining; a machining type determination unit configured to determine a machining type for each machining time period for the machine tool, based on the collected data; and a data exclusion unit that, in a case where the determined machining type is an exclusion-target machining type for which collection of data is preset to unnecessary, excludes data on the machining time period for the determined machining type.

(4) One aspect of a control device according to the present disclosure is provided with the diagnosis data collection device according to (1).

### Effects of the Invention

By virtue of one aspect, it is possible to quickly determine the type of machining having no relation to a diagnosis and exclude waveform data of the machining without saving said waveform data to thereby suppress an increase in data.

### BRIEF DESCRIPTION OF THE DRAWINGS

FIG. 1 is a functional block diagram that illustrates an example of a functional configuration of a diagnosis data collection system according to a first embodiment;

FIG. 2 is a view that illustrates an example of waveform data in a case of tapping;

FIG. 3 is a view that illustrates an example of waveform data in a case of milling;

FIG. 4 is a view that illustrates an example of waveform data in a case of drilling;

FIG. 5 is a flow chart for describing a data collection process by a diagnosis data collection device;

FIG. 6 is a flow chart for describing detailed processing content in a machining type determination process indicated in Step S1 in FIG. 5;

FIG. 7 is a flow chart for describing detailed processing content in a data exclusion process indicated in Step S2 in FIG. 5;

FIG. 8 is a functional block diagram that illustrates an example of a functional configuration of a diagnosis data collection system according to a second embodiment;

FIG. 9 is a view that illustrates an example of teaching data; and

FIG. 10 is a view that illustrates an example of a result of machine learning in a case of clustering.

### PREFERRED MODE FOR CARRYING OUT THE INVENTION

With reference to the drawings, description is given in detail regarding a first embodiment and a second embodiment of a diagnosis data collection device.

Here, the embodiments share a configuration of collecting, in time series, waveform data for when a machine tool performs machining, determining a machining type for each machining time period for the machine tool based on the collected waveform data and, if the determined machining type is an exclusion-target machining type for which collection of data is preset to unnecessary, excluding, as an exclusion target, the waveform data pertaining to the exclusion-target machining type and the machining time period thereof.

However, for the determination of a machining type, waveform data collected in the first embodiment includes at least a coordinate value for a drive shaft included in a machine tool as well as an operational state, and a machining type for a machining time period for the machine tool is determined based on the coordinate value and the operational state. In contrast to this, the second embodiment differs to the first embodiment in generating a trained model by executing machine learning using teaching data, the teaching data being input data that is waveform data for any machining by a machine tool as well as label data that indicates a machining type of the any machining, and using the generated trained model and collected waveform data to determine a machining type for a machining time period for the machine tool.

Description is first given in detail below regarding the first embodiment, and subsequently description is given mainly for portions in the second embodiment that differ to the first embodiment.

### FIRST EMBODIMENT

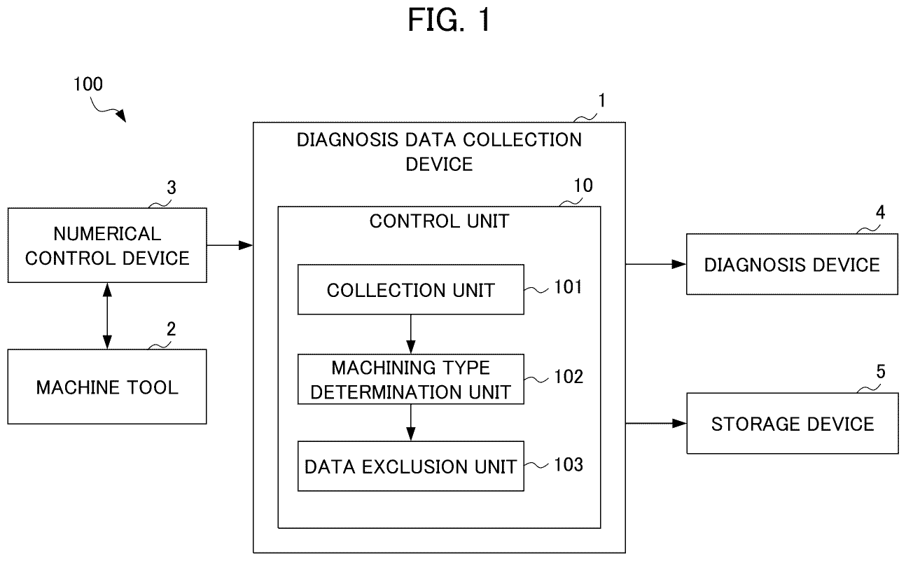

FIG. 1 is a functional block diagram that illustrates an example of a functional configuration of a diagnosis data collection system according to the first embodiment. Here, a case is exemplified in which drilling and tapping are given as machining types that are targeted for data collection and milling is given as an exclusion-target machining type for which data collection has been preset to unnecessary. Note that the present invention is not limited to setting drilling and tapping as machining types that are targeted for data collection and setting milling as an exclusion-target machining type, and can also be applied after setting any machining other than drilling and tapping as a machining type that is targeted for data collection, and setting any machining other than milling as an exclusion-target machining type.

As illustrated in FIG. 1, a diagnosis data collection system 100 has a diagnosis data collection device 1, a machine tool 2, a numerical control device 3, a diagnostic device 4, and a storage device 5.

The diagnosis data collection device 1, the machine tool 2, the numerical control device 3, the diagnostic device 4, and the storage device 5 may be mutually connected via a network (not shown) such as a local area network (LAN) or the internet. In this case, the diagnosis data collection device 1, the machine tool 2, the numerical control device 3, the diagnostic device 4, and the storage device 5 are each provided with a communication unit (not shown) for communicating with each other via a corresponding connection. Note that the diagnosis data collection device 1, the machine tool 2, the numerical control device 3, the diagnostic device 4, and the storage device 5 may be directly connected to each other in a wired or wireless manner, via a connection interface (not shown).

In addition, the diagnosis data collection device 1 is given as a device that is different to the numerical control device 3 in FIG. 1, but may be included in the numerical control device 3. The numerical control device 3 is also given as a device that is different to the machine tool 2, but may be included in the machine tool 2.

In addition, the diagnostic device 4 and the storage device 5 are given as devices that are different to the diagnosis data collection device 1, but may be included in the diagnosis data collection device 1.

<Machine tool 2>

The machine tool 2 is, for example, a machine tool that has, inter alia, three or five axes and is publicly known to a person skilled in the art, and operates based on an operation command from the numerical control device 3, which is described below.

### <Numerical Control Device 3>

The numerical control device 3 is a numerical control device that is publicly known to a person skilled in the art, and generates a command based on execution of control information, and transmits the generated command to the machine tool 2. As a result, the numerical control device 3 controls operation by the machine tool 2. In addition, while controlling the machine tool 2, the numerical control device 3 outputs, to the later-described diagnosis data collection device 1, data such as coordinate values for a drive shaft such as a spindle, the operational state of the machine tool 2, and the spindle speed.

### <Diagnostic Device 4>

The diagnostic device 4 is, for example, a tool breakage detection device that performs tool breakage detection (for example, Patent Document 1), a tool wear monitoring device that performs tool wear monitoring (for example, Patent Document 2 or 3), a failure prediction device that performs a failure prediction (for example, Patent Document 4), or the like. The diagnostic device 4 uses waveform data collected by the later-described diagnosis data collection device 1 to perform tool breakage detection, tool wear monitoring, failure prediction, or the like.

### <Storage Device 5>

The storage device 5 is, inter alia, a data server that has an SSD (solid-state drive), an HDD (hard disk drive), or the like and stores waveform data collected by the later-described diagnosis data collection device 1.

### <Diagnosis Data Collection Device 1>

For example, the diagnosis data collection device 1 is, inter alia, a publicly known computer, and has a control unit 10 as illustrated in FIG. 1. In addition, the control unit 10 has a collection unit 101, a machining type determination unit 102, and a data exclusion unit 103.

### <Control Unit 10>

The control unit 10 is something publicly known to a person skilled in the art that has a CPU, a ROM, a RAM, a CMOS memory, etc., with each of these configured to be able to mutually communicate via a bus.

The CPU is a processor that comprehensively controls the diagnosis data collection device 1. The CPU reads out, via the bus, a system program and an application program that are stored in the ROM, and controls the entirety of the diagnosis data collection device 1 in accordance with a system program and the application program. As a result, as illustrated in FIG. 1, the control unit 10 is configured so as to realize functionality for the collection unit 101, the machining type determination unit 102, and the data exclusion unit 103. Various data such as temporary calculation data or display data is stored in the RAM. In addition, the CMOS memory is supported by a battery (not shown), and is configured as a non-volatile memory for which a storage state is held even if a power supply for the diagnosis data collection device 1 is turned off.

For example, via the numerical control device 3, the collection unit 101 in time series collects, as waveform data, data such as coordinate values for a drive shaft such as the spindle when the machine tool 2 is performing machining, the operational state of the machine tool 2, and the spindle speed. The collection unit 101 outputs the collected waveform data to the machining type determination unit 102. Note that the operational state indicates a state (on or off) of a during-cutting signal, a during-tapping signal, or the like.

The machining type determination unit 102, for example, uses a procedural method to determine a machining type for a machining time period for the machine tool 2, based on waveform data until the end of a prescribed time period (for example, 30 seconds, one minute, etc.) from the start of machining, from among waveform data collected by the collection unit 101.

Specifically, the machining type determination unit 102, for example, samples the waveform data until the end of the prescribed time period from the start of the machining time period, and temporarily saves the sampled waveform data in a memory such as the RAM. Note that a user defines the machining time period by a range designation in accordance with the spindle undergoing normal rotation, a tool that is selected, and a sequence number (or a block number). The machining time period also includes an operational state or a current program command (M/S/T code) with which it is understood that machining is underway.

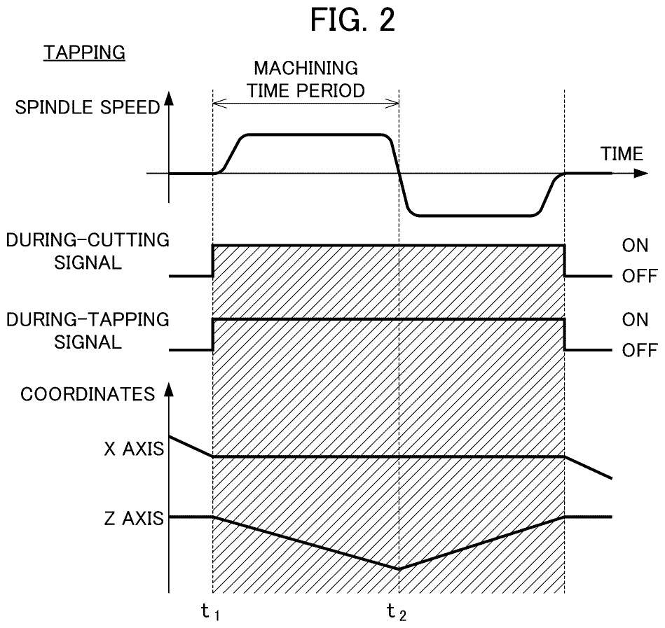

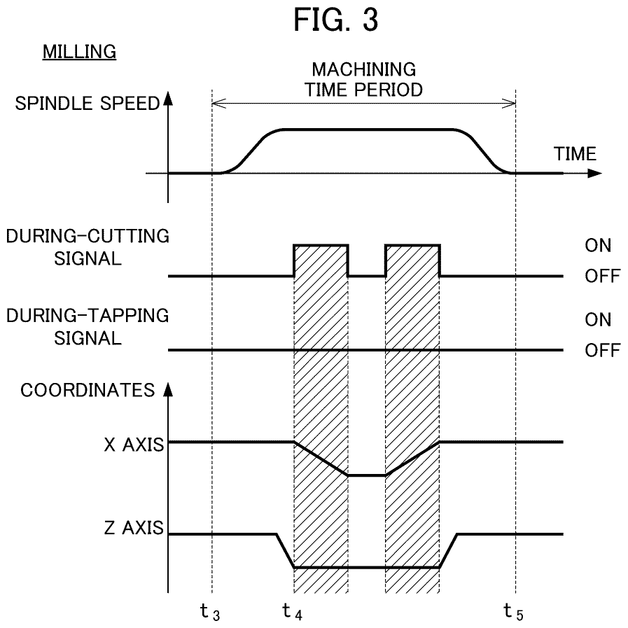

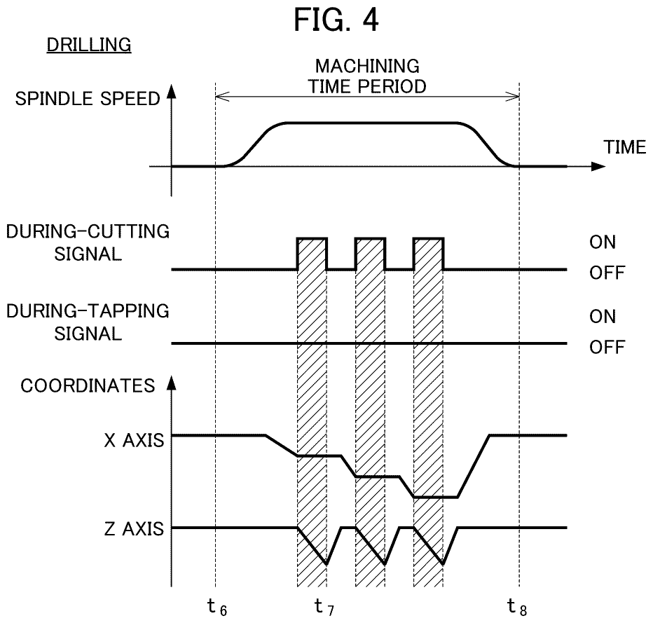

FIG. 2 is a view that illustrates an example of waveform data in a case of tapping. FIG. 3 is a view that illustrates an example of waveform data in a case of milling. FIG. 4 is a view that illustrates an example of waveform data in a case of drilling. In FIG. 2 through FIG. 4, the horizontal axis indicates time, and the vertical axis indicates spindle speed, the state of the during-cutting signal, the state of the during-tapping signal, and coordinate values for the X axis and the Z axis. Note that coordinate values for the Y axis are omitted in FIG. 2 through FIG. 4. In addition, time periods in which the during-cutting signal is on are illustrated as shaded in FIG. 2 through FIG. 4.

The machining type determination unit 102 determines that the machining type in FIG. 2 is tapping because the during-tapping signal, which indicates an operational state in a machining time period from a time t1 to a time t2 (where the during-cutting signal is on), has changed from off to on at the time t1 as illustrated in FIG. 2.

In addition, the machining type determination unit 102 determines that the machining type in FIG. 3 is milling because the XY axes start to move at a time t4 when the during-cutting signal first becomes on in a machining time period from a time t3 to a time t5 as illustrated in FIG. 3. In addition, the machining type determination unit 102 determines that the machining type in FIG. 4 is drilling because there is no movement of the XY axes while the during-tapping signal is off at the time t7 when opening of a first hole ends at the machining time period from the time t6 to the time t8, as illustrated in FIG. 4.

In a case where the determined machining type is an exclusion-target machining type for which data collection is preset to unnecessary, the data exclusion unit 103 excludes data pertaining to the determined machining type and the machining time period thereof.

Specifically, in a case where the determined machining type corresponds to a collection-target machining type for which collection of waveform data is preset to necessary (for example, in a case where drilling or tapping is set to the collection-target machining type), the data exclusion unit 103 outputs waveform data from the start to the end of the machining time period to the diagnostic device 4 and/or the storage device 5. In contrast, in a case where the determined machining type corresponds to an exclusion-target machining type for which collection of waveform data is preset to unnecessary (for example, in a case where milling is set to the exclusion-target machining type), the data exclusion unit 103 excludes (deletes), as an exclusion target, waveform data from the start to the end of the machining time period, and does not output the waveform data to the diagnostic device 4 or the storage device 5.

### <Data Collection Process by Diagnosis Data Collection Device 1>

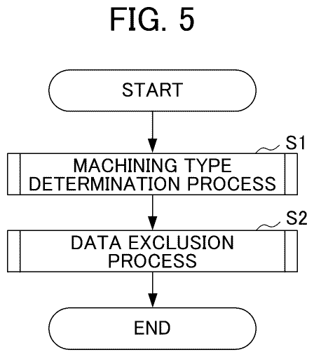

Next, with reference to FIG. 5, a flow for a data collection process by the diagnosis data collection device 1 is described.

FIG. 5 is a flow chart for describing a data collection process by the diagnosis data collection device 1. The flow illustrated here is repeatedly executed each time the machine tool 2 performs machining.

In Step S1, via the numerical control device 3, the collection unit 101 collects waveform data such as coordinate values for a drive shaft such as the spindle when the machine tool 2 is performing machining, the operational state of the machine tool 2, and the spindle speed. The machining type determination unit 102 performs a machining type determination process based on waveform data until the end of a prescribed time period (for example, 30 seconds, one minute, etc.) from the start of machining, and uses a procedural method to determine a machining type for a machining time period for the machine tool 2. Note that a detailed flow for the machining type determination process is described below.

In Step S2, the data exclusion unit 103 performs a data exclusion process based on the machining type determined in Step S1 and, in a case where the determined machining type corresponds to an exclusion-target machining type for which collection of waveform data is preset to unnecessary (for example, a case where milling is set to an exclusion-target machining type), excludes, as an exclusion target, waveform data pertaining to the determined machining type and the machining time period thereof. Note that a detailed flow for the data exclusion process is described below.

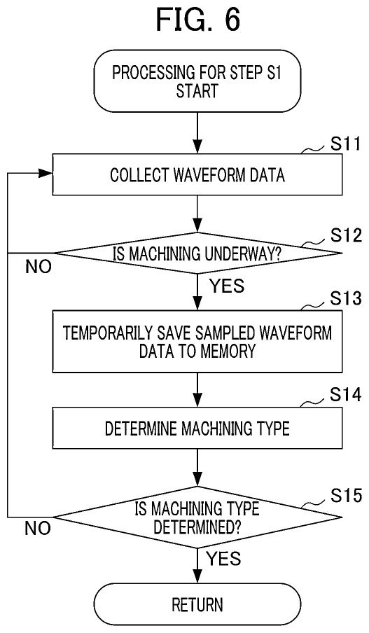

FIG. 6 is a flow chart for describing detailed processing content in a machining type determination process indicated in Step S1 in FIG. 5.

In Step S11, via the numerical control device 3, the collection unit 101 collects waveform data such as coordinate values for a drive shaft such as the spindle when the machine tool 2 is performing machining, the operational state of the machine tool 2, and the spindle speed.

In Step S12, the machining type determination unit 102 determines whether the waveform data collected in Step S11 is data collected during machining by the machine tool 2. In a case where the collected waveform data is data collected during machining by the machine tool 2, the process proceeds to Step S13. In contrast, in a case where the collected waveform data is not data collected during machining by the machine tool 2, the process returns to Step S11 in order to collect waveform data while machining is underway.

In Step S13, the machining type determination unit 102 samples waveform data until the end of a prescribed time period (for example, 30 seconds, one minute, etc.) from the start of a machining time period, and temporarily saves the sampled waveform data in a memory.

In Step S14, the machining type determination unit 102 uses the waveform data that was temporarily saved in the memory in Step S13 to determine a machining type.

In Step S15, the machining type determination unit 102 determines whether a machining type was able to be determined in Step S14. In a case where it was possible to determine a machining type, the diagnosis data collection device 1 ends the machining type determination process and proceeds to Step S2. In contrast, in a case where it was not possible to determine a machining type, it is assumed that there is a need to further continue sampling in order to distinguish the machining type, the process returns to Step S11, and waveform data while machining is underway is collected.

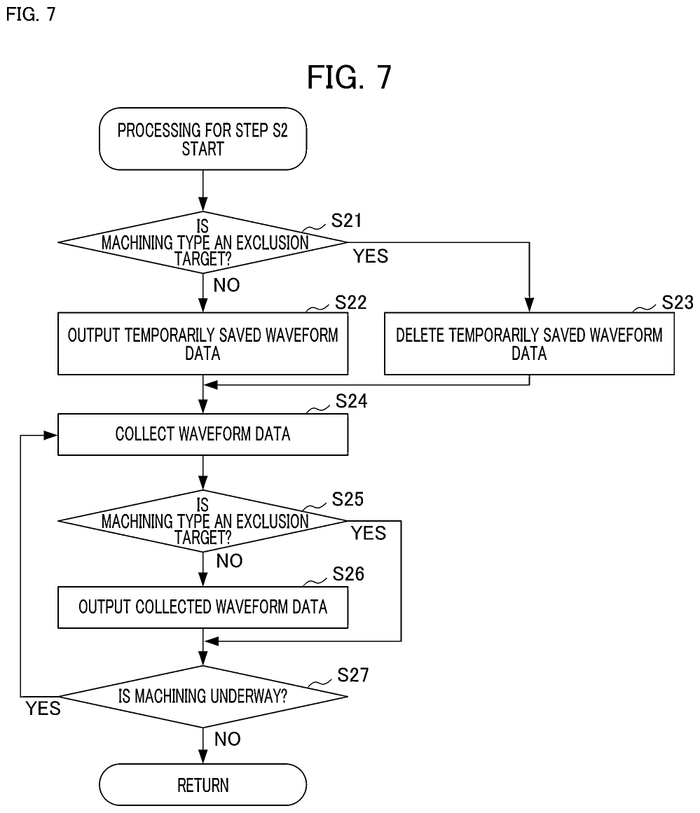

FIG. 7 is a flow chart for describing detailed processing content in a data exclusion process indicated in Step S2 in FIG. 5.

In Step S21, the data exclusion unit 103 determines whether the machining type that is for the waveform data and was determined in Step S1 is an exclusion-target machining type. In a case where the machining type for the waveform data is an exclusion-target machining type, the process proceeds to Step S23. In contrast, in a case where the machining type for the waveform data is not an exclusion-target machining type—in other words, is a collection-target machining type, the process proceeds to Step S22.

In Step S22, the data exclusion unit 103 outputs the waveform data, which was temporarily saved in Step S1, to the diagnostic device 4 and/or the storage device 5.

In Step S23, the data exclusion unit 103 deletes the waveform data that was temporarily saved in Step S1.

In Step S24, via the numerical control device 3, the collection unit 101 collects waveform data such as coordinate values for a drive shaft such as the spindle when the machine tool 2 is performing machining, the operational state of the machine tool 2, and the spindle speed.

In Step S25, the data exclusion unit 103 determines, from the machining type that is for the waveform data and was determined in Step S1, whether the waveform data collected in Step S24 is an exclusion-target machining type. In a case where the machining type for the waveform data is an exclusion-target machining type, the process proceeds to Step S27. In contrast, in a case where the machining type for the waveform data is not an exclusion-target machining type—in other words, is a collection-target machining type, the process proceeds to Step S26.

In Step S26, the data exclusion unit 103 outputs the waveform data, which was collected in Step S24, to the diagnostic device 4 and/or the storage device 5.

In Step S27, the data exclusion unit 103 determines whether the waveform data collected in Step S24 is data collected during machining by the machine tool 2. In a case where the waveform data is data collected during machining by the machine tool 2, it is assumed that machining is continuing, and the process returns to Step S24. In contrast, in a case where the waveform data is not data collected during machining by the machine tool 2, it is assumed that machining has ended, and the diagnosis data collection device 1 ends the data exclusion process.

As above, the diagnosis data collection device 1 according to the first embodiment temporarily saves, in a memory, waveform data until the end of a prescribed time period (for example, 30 seconds, one minute, etc.) from the start of machining, from among collected waveform data, and uses the saved waveform data to determine a machining type for a machining time period for the machine tool 2, in accordance with a procedural method. In a case where the determined machining type corresponds to a collection-target machining type for which collection of waveform data is preset to necessary (for example, in a case where drilling or tapping is set to the collection-target machining type), the diagnosis data collection device 1 outputs waveform data pertaining to the determined machining type and the machining time period thereof to the diagnostic device 4 and/or the storage device 5. In contrast, in a case where the determined machining type corresponds to an exclusion-target machining type for which collection of waveform data is preset to unnecessary (for example, in a case where milling is set as an exclusion-target machining type), the diagnosis data collection device 1 deletes the temporarily saved waveform data for this machining type and excludes waveform data pertaining to the determined machining type and the machining time period thereof. As a result, the diagnosis data collection device 1 can quickly determine the type of machining having no relation to a diagnosis and exclude waveform data of the machining without saving said waveform data to thereby suppress an increase in data.

In addition, the diagnosis data collection device 1 can suppress an increase in a required memory capacity. In other words, the diagnosis data collection device 1 becomes able to save waveform data for a substantially long period of time, even if the capacity of the storage device 5 which is for saving data is low, and the diagnostic device 4, which has little memory capacity, becomes able to use data that corresponds to a substantially long period of time.

In addition, the diagnosis data collection device 1 is able to suppress a cost increase that accompanies an increase in the required memory capacity.

Description was given above regarding the first embodiment.

### Second Embodiment

Next, description is given regarding a second embodiment. Waveform data collected in the first embodiment includes at least a coordinate value for a drive shaft included in a machine tool as well as an operational state, and a machining type for a machining time period for the machine tool is determined based on the coordinate value and the operational state. In contrast to this, the second embodiment differs to the first embodiment in generating a trained model by executing machine learning using teaching data, the teaching data being input data that is waveform data for any machining by a machine tool as well as label data that indicates a machining type of the any machining, and using the generated trained model and collected waveform data to determine a machining type for a machining time period for the machine tool.

As a result, the diagnosis data collection device 1A according to the second embodiment can quickly determine the type of machining having no relation to a diagnosis and exclude waveform data of the machining without saving said waveform data to thereby suppress an increase in data.

Description is given below regarding the second embodiment.

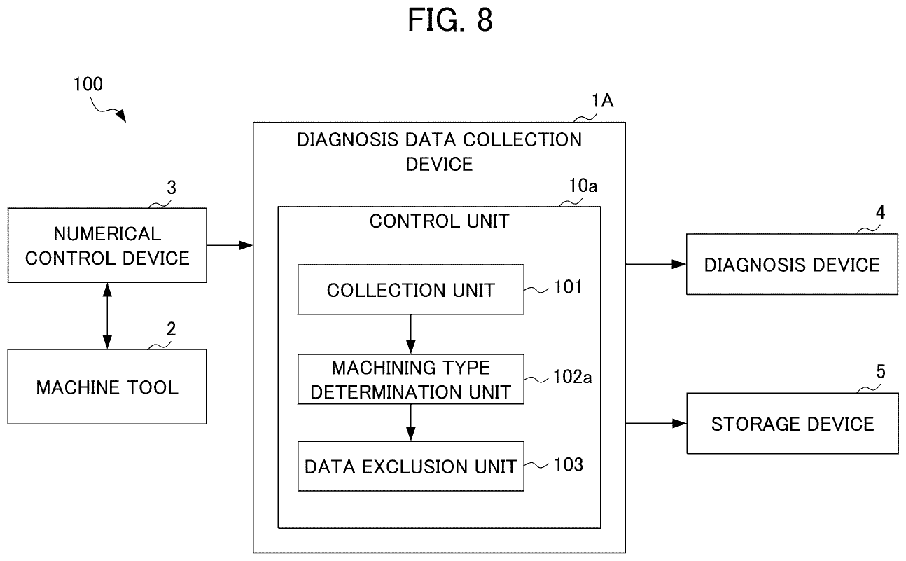

FIG. 8 is a functional block diagram that illustrates an example of a functional configuration of a diagnosis data collection system according to the second embodiment. Note that the same reference symbols are added to elements having similar functionality to elements in the diagnosis data collection system 1 in FIG. 1, and detailed description thereof is omitted.

As illustrated in FIG. 8, a diagnosis data collection system 100 has a diagnosis data collection device 1A, a machine tool 2, a numerical control device 3, a diagnostic device 4, and a storage device 5.

The machine tool 2, the numerical control device 3, the diagnostic device 4, and the storage device 5 have equivalent functionality to that of the machine tool 2, the numerical control device 3, the diagnostic device 4, and the storage device 5 in the first embodiment.

### <Diagnosis Data Collection Device 1A>

As illustrated in FIG. 8, the diagnosis data collection device 1A includes a control unit 10a. In addition, the control unit 10a has a collection unit 101, a machining type determination unit 102a, and a data exclusion unit 103.

The collection unit 101 and the data exclusion unit 103 have equivalent functionality to that of the collection unit 101 and the data exclusion unit 103 in the first embodiment.

The machining type determination unit 102a generates a trained model by executing machine learning using teaching data, the teaching data being input data that is waveform data for any machining by the machine tool 2 as well as label data that indicates a machining type of the any machining, and uses the generated trained model and collected waveform data to determine a machining type for a machining time period for the machine tool 2.

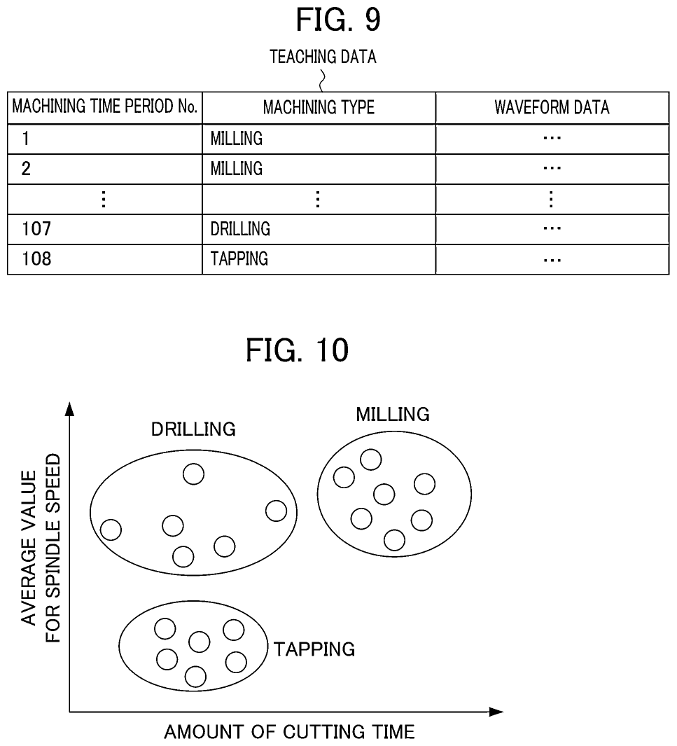

Specifically, for example, in a training phase, the machining type determination unit 102a prepares in advance, as teaching data for training, a plurality of sets of waveform data and data (label data) that indicates an actual machining type within the waveform data as illustrated in FIG. 9, and stores the sets in, inter alia, the storage device 5 or a storage unit (not shown) such as an HDD that is included in the diagnosis data collection device 1A.

FIG. 9 is a view that illustrates an example of teaching data.

As illustrated in FIG. 9, the teaching data has storage regions for “machining time period No.”, “machining type”, and “waveform data”.

The storage region for “machining time period No.” within the teaching data stores a number that indicates an order at which storage as teaching data was performed, for example. Note that 108 items of teaching data are given as stored in FIG. 9, but there is no limitation to this, and any number of items of teaching data may be stored.

The storage region for “machining type” within the teaching data stores a machining type such as “milling”, “drilling”, or “tapping”, for example.

For example, the storage region for “waveform data” within the teaching data stores waveform data that has been sampled by the machine tool 2 each machining time period corresponding to “machining time period No.”. Note that a sampling time period is assumed to be a prescribed time period (for example, 30 seconds, one minute, etc.) that is from the start of the machining time period and until cutting has advanced to a certain extent.

As a result, the diagnosis data collection device 1A determines an exclusion-target machining type from the sampled data for the prescribed time period, whereby it is possible to prevent saving unnecessary waveform data.

In a training phase, the machining type determination unit 102a samples waveform data for each machining time period for the teaching data in FIG. 9, and generates a feature amount vector from the sampled data.

Here, a feature vector is an N-dimensional vector (N is an integer that is greater than or equal to 2) having as components a maximum value for motor torque, an average value for motor speed, an amount of cutting time, or the like, for example. Note that the feature vector is described below as a two-dimensional vector having an amount of cutting time and an average value for spindle speed, but a feature vector that is an N-dimensional vector where N is not 2 is similar to the case of two dimensions, and description therefor is omitted. In addition, the amount of cutting time is not the overall amount of time for cutting, but indicates a total amount of time for cutting feeding operations.

The machining type determination unit 102a generates a trained model by executing machine learning using machining type label data as well as input data that is a feature vector for each machining time period in the teaching data illustrated in FIG. 9. For example, the machining type determination unit 102a stores the generated trained model in a storage unit (not shown) in the diagnosis data collection device 1A. Note that description is given below for a case of clustering as machine learning, but machine learning may be a support vector machine (SVM), deep learning, or the like.

FIG. 10 is a view that illustrates an example of a result of machine learning in a case of clustering.

As illustrated in FIG. 10, a cluster for each machining type is generated as a trained model. In other words, a milling cluster has feature amount tendencies in that there is a long amount of cutting time and a high average value for spindle speed. In addition, a drilling cluster has feature amount tendencies in that there is a short amount of cutting time and a high average value for spindle speed. In addition, a tapping cluster has feature amount tendencies in that there is a short amount of cutting time and a low average value for spindle speed.

In an operation phase (determination phase), the machine tool 2 continuously operates and the collection unit 101 collects waveform data, whereby the machining type determination unit 102a samples waveform data from the start of the machining time period until the end of a prescribed time period. The machining type determination unit 102a generates a feature vector from current sampled data, and inputs the generated feature vector to the trained model to thereby obtain the distance to each machining type cluster. The machining type determination unit 102a determines the machining type for the cluster having the shortest distance to the feature vector as the machining type for the waveform data. Here, the distance is a Euclidean distance, a Mahalanobis distance, or the like.

Note that a data collection process, a machining type determination process, and a data exclusion process by the diagnosis data collection device 1A in the operation phase (determination phase) are similar to the case of the first embodiment illustrated in FIG. 5 through FIG. 7, and detailed description thereof is omitted.

As above, the diagnosis data collection device 1A according to the second embodiment prepares teaching data in advance, the teaching data being input data that is waveform data for any machining by the machine tool 2 and label data that indicates the machining type of the any machining, and uses the teaching data to execute machine learning and thereby generate a trained model. The diagnosis data collection device 1A uses the generated trained model and collected waveform data to determine a machining type for a machining time period for the machine tool 2. In a case where the determined machining type corresponds to a collection-target machining type for which collection of waveform data is preset to necessary (for example, in a case where drilling or tapping is set as a collection-target machining type), the diagnosis data collection device 1A outputs waveform data pertaining to the determined machining type and the machining time period thereof to the diagnostic device 4 and/or the storage device 5. In contrast, in a case where the determined machining type corresponds to an exclusion-target machining type for which collection of waveform data is preset to unnecessary (for example, in a case where milling is set as an exclusion-target machining type), the diagnosis data collection device 1A deletes the temporarily saved waveform data for this machining type and excludes waveform data pertaining to the machining time period. As a result, the diagnosis data collection device 1A can quickly determine the type of machining having no relation to a diagnosis and exclude waveform data of the machining without saving said waveform data to thereby suppress an increase in data.

In addition, the diagnosis data collection device 1A can suppress an increase in a required memory capacity. In other words, the diagnosis data collection device 1A becomes able to save a waveform data for a substantially long period of time, even if the capacity of the storage device 5 which is for saving data is low, and the diagnostic device 4, which has little memory capacity, becomes able to use data that corresponds to a substantially long period of time.

In addition, the diagnosis data collection device 1A is able to suppress a cost increase that accompanies an increase in the required memory capacity.

Description was given above regarding the second embodiment.

This concludes the description above regarding the first embodiment and the second embodiment, but the diagnosis data collection devices 1 and 1A are not limited to the embodiments described above, and include variations, improvements, etc. in a scope that enables the objective to be achieved.

### <First Variation>

In the first embodiment and the second embodiment, description is given of cases in which machining types are milling, drilling, and tapping for the diagnosis data collection devices 1 and 1A, but there is no limitation to this. For example, lathe-turning using a cutter (a tool), laser processing, punch press machining, electrical discharge machining, or the like may be included as machining types for the diagnosis data collection devices 1 and 1A.

### <Second Variation>

As another example, the diagnosis data collection devices 1 and 1A are given as different to the numerical control device 3 in the embodiments described above, but there is no limitation to this. For example, the diagnosis data collection device 1 or 1A may be included in the numerical control device 3. In addition, the diagnosis data collection device 1 or 1A may include the diagnostic device 4 and the storage device 5.

In addition, for example, some or all of the collection unit 101, the machining type determination unit 102, and the data exclusion unit 103 in the diagnosis data collection device 1 or some or all of the collection unit 101, the machining type determination unit 102a, and the data exclusion unit 103 in the diagnosis data collection device 1A may be provided in a server. In addition, each function by the diagnosis data collection devices 1 and 1A may be realized using a cloud-based virtual server function or the like.

Furthermore, the diagnosis data collection devices 1 and 1A may be distributed processing systems in which the functions of the diagnosis data collection devices 1 and 1A are distributed among a plurality of servers, as appropriate.

Note that each function included in the diagnosis data collection devices 1 and 1A according to the first embodiment and the second embodiment can be realized by hardware, software, or a combination of these. Being realized by software means being realized by a computer reading and executing a program.

A program can be stored using various types of non-transitory computer-readable mediums and supplied to a computer. A non-transitory computer-readable medium includes various types of tangible storage mediums. An example of a non-transitory computer-readable medium includes a magnetic recording medium (for example, a floppy disk, magnetic tape, or a hard disk drive), a magneto-optical recording medium (for example, a magneto-optical disk), a CD-ROM (read-only memory), CD-R, CD-R/W, and a semiconductor memory (for example, a mask ROM, a programmable ROM (PROM), an erasable PROM (EPROM), a flash ROM, or a RAM). In addition, a program may be supplied to a computer by various types of transitory computer-readable mediums. An example of a transitory computer-readable medium includes an electrical signal, an optical signal, or electromagnetic waves. A transitory computer-readable medium can supply a program to a computer via wired communication channel such as an electrical wire or an optical fiber, or via a wireless communication channel.

Note that steps that express a program recorded to a recording medium of course include processing in chronological order following the order of these steps, but also include processing that is executed in parallel or individually, with no necessity for processing to be performed in chronological order.

To rephrase, the diagnosis data collection device, diagnosis data collection method, recording medium, and control device according to the present disclosure can have various embodiments that can have configurations such as the following.

(1) The diagnosis data collection device 1 according to the present disclosure is the diagnosis data collection device 1 or 1A that is for collecting data for diagnosing the machine tool 2 that performs machining constituted by a plurality of machining types, the diagnosis data collection device 1 or 1A including: the collection unit 101 that collects, in time series, data when the machine tool 2 is machining; the machining type determination unit 102 or 102a that determines a machining type for each machining time period for the machine tool 2, based on the collected data; and the data exclusion unit 103 that, in a case where the determined machining type is an exclusion-target machining type for which collection of data is preset to unnecessary, excludes data on the machining time period for the determined machining type. By virtue of this diagnosis data collection device 1 or 1A, it is possible to quickly determine the type of machining having no relation to a diagnosis and exclude waveform data for the machining without saving said waveform data to thereby suppress an increase in data.

(2) In the diagnosis data collection device 1 according to (1), it may be that the data collected by the collection unit 101 includes at least an operational state and a coordinate value for a drive shaft included in the machine tool 2, and the machining type determination unit 102 determines the machining type for the machining time period for the machine tool 2 based on the operational state and the coordinate value.

As a result, the diagnosis data collection device 1 can accurately determine the machining type.

(3) In the diagnosis data collection device 1A according to (1), it may be that the machining type determination unit 102a generates a trained model by executing machine learning using teaching data, the teaching data being input data that is data for any machining by the machine tool 2 as well as label data that indicates a machining type of the any machining, and uses the generated trained model and collected waveform data to determine a machining type for a machining time period for the machine tool 2.

As a result, it is possible to flexibly support even if there are more machining types.

(4) A diagnosis data collection method according to the present disclosure is for collecting data for diagnosing the machine tool 2 that performs machining constituted by a plurality of machining types, the diagnosis data collection method comprising: a collection step of collecting, in time series, data when the machine tool 2 is machining; a machining type determination step of determining a machining type for each machining time period for the machine tool 2, based on the collected data; and a data exclusion step of, in a case where the determined machining type is an exclusion-target machining type for which collection of data is preset to unnecessary, excluding data on the machining time period for the determined machining type.

By virtue of this diagnosis data collection method, a similar effect to that for (1) can be achieved.

(5) A recording medium according to the present disclosure is a computer-readable recording medium on which is recorded a program for causing a computer to, in order to collect data for diagnosing the machine tool 2 that performs machining constituted by a plurality of machining types, function as: the collection unit 101 that collects, in time series, data when the machine tool 2 is machining; the machining type determination unit 102 or 102a that determines a machining type for each machining time period for the machine tool 2, based on the collected data; and the data exclusion unit 103 that, in a case where the determined machining type is an exclusion-target machining type for which collection of data is preset to unnecessary, excludes data on the machining time period for the determined machining type.

By virtue of this recording medium, a similar effect to that for (1) can be achieved.

(6) The numerical control device 3 according to the present disclosure is provided with the diagnosis data collection device 1 or 1A according to (1).

By virtue of this numerical control device 3, a similar effect to that for (1) can be achieved.

### EXPLANATION OF REFERENCE NUMERALS

1, 1A Diagnosis data collection device
10, 10a Control unit
101 Collection unit
102, 102a Machining type determination unit
103 Data exclusion unit
2 Machine tool
3 Numerical control device
4 Diagnostic device
5 Storage device
100 Diagnosis data collection system

1. A diagnosis data collection device for collecting data for diagnosing a machine tool that performs machining constituted by a plurality of machining types, the diagnosis data collection device comprising:
a collection unit configured to collect, in time series, data when the machine tool is machining;
a machining type determination unit configured to determine a machining type for each machining time period for the machine tool, based on the collected data; and
a data exclusion unit configured to, in a case where the determined machining type is an exclusion-target machining type for which collection of data is preset to unnecessary, exclude data on the machining time period for the determined machining type.

2. The diagnosis data collection device according to claim 1, wherein
the data collected by the collection unit includes at least an operational state and a coordinate value for a drive shaft included in the machine tool, and
the machining type determination unit determines the machining type for the machining time period for the machine tool based on the operational state and the coordinate value.

3. The diagnosis data collection device according to claim 1, wherein
the machining type determination unit generates a trained model by executing machine learning using teaching data, the teaching data being input data that is data for any machining by the machine tool as well as label data that indicates a machining type of the any machining, and uses the generated trained model and collected waveform data to determine the machining type for the machining time period for the machine tool.

4. A diagnosis data collection method for collecting data for diagnosing a machine tool that performs machining constituted by a plurality of machining types, the diagnosis data collection method comprising:
a collection step of collecting, in time series, data when the machine tool is machining;
a machining type determination step of determining a machining type for each machining time period for the machine tool, based on the collected data; and
a data exclusion step of, in a case where the determined machining type is an exclusion-target machining type for which collection of data is preset to unnecessary, excluding data on the machining time period for the determined machining type.

5. A non-transitory computer readable medium on which is recorded a program for causing a computer to, in order to collect data for diagnosing a machine tool that performs machining constituted by a plurality of machining types, function as:
a collection unit configured to collect, in time series, data when the machine tool is machining;
a machining type determination unit configured to determine a machining type for each machining time period for the machine tool, based on the collected data; and
a data exclusion unit configured to, in a case where the determined machining type is an exclusion-target machining type for which collection of data is preset to unnecessary, exclude data on the machining time period for the determined machining type.

6. A control device, comprising the diagnosis data collection device according to claim 1.
